(19) United States
(12) Patent Application Publication
(10) Pub. No.: US 2015/0333943 A1
(43) Pub. Date: Nov. 19, 2015

(54) JOINT PAPR REDUCTION AND RATE ADAPTIVE ULTRASONIC OFDM PHYSICAL LAYER FOR HIGH DATA RATE THROUGH-METAL COMMUNICATIONS

(71) Applicant: DREXEL UNIVERSITY, Philadelphia, PA (US)

(72) Inventors: Richard Primerano, Philadelphia, PA (US); Kevin Wanuga, Philadelphia, PA (US); Magdalena Bielinski, North Effort, PA (US); Kapil R. Dandekar, Philadelphia, PA (US); Moshe Kam, Philadelphia, PA (US); Guillermo Sosa, Montevideo (UY)

(73) Assignee: DREXEL UNIVERSITY, Philadelphia, PA (US)

(21) Appl. No.: 14/138,188

(22) Filed: Dec. 23, 2013

Related U.S. Application Data
(63) Continuation of application No. 14/119,338, filed on Feb. 19, 2014, now abandoned.
(60) Provisional application No. 61/490,321, filed on May 26, 2011.

(51) Int. Cl. H04L 27/26; H04L 27/01; H04L 5/00; H04L 27/36

(52) U.S. Cl. CPC H04L 27/262; H04L 27/362; H04L 27/01; H04L 5/0007

(57) ABSTRACT

A link adaptive orthogonal frequency-division multiplexed (OFDM) ultrasonic physical layer is provided that is capable of high data rate communication through metallic structures. The use of an adaptive OFDM subcarrier-based modulation technique mitigates the effects of severe frequency selective fading of the through-metal communication link and improves spectral efficiency by exploiting the slow-varying nature of the channel. To address the potential ill effects of peak-to-average power ratio (PAPR) and to make more efficient use of the power amplifiers in the system, the invention modifies and implements a symbol rotation and inversion-based PAPR reduction algorithm in the adaptive OFDM framework. This joint adaptive physical layer is capable of increasing data rates by roughly 220% in comparison to conventional narrowband techniques at average transmit powers of roughly 7 mW while constrained to a desired BER.

### CROSS-REFERENCE TO RELATED APPLICATIONS

The present application is a Continuation of U.S. patent application Ser. No. 14/119,338 filed Nov. 21, 2013, which is a National Phase of PCT/US2012/039686 filed May 25, 2012, which claims priority to U.S. Provisional Patent Application No. 61/490,321, filed May 26, 2011. The contents of that application are hereby incorporated by reference.

### STATEMENT OF FEDERALLY SPONSORED RESEARCH

This invention was made with government support under research Grant Nos. #CNS-0923003 and #CNS-0854946 awarded by the National Science Foundation and research Grant Nos. N00014-11-1-0329 and N00014-12-1-0262 and Project #N05-T020 funded by the Office of Naval Research. The United States Government has certain rights in the invention.

### TECHNICAL FIELD

The present invention relates to wireless communications techniques. More particularly, the present invention relates to high data rate communications through metal walls by combining the benefits of subcarrier-based rate adaptive bit loading and peak to average power ratio (PAPR) reduction through frequency domain symbol rotation in an adaptive orthogonal frequency-division multiplexed (OFDM) ultrasonic physical layer.

### BACKGROUND

Industrial control networks often require data transmission in environments where metallic structures inhibit connectivity. In many applications, it is undesirable to physically penetrate the structure (pressurized pipelines, watertight bulkheads, armor plating, etc.). Ultrasonic wireless links can alleviate this issue by through-metal data communication rather than compromising the structural integrity of the barrier through the use of mechanical penetration. However, ultrasonic links can be a bottleneck to network traffic due to sound wave propagation latency and the reverberant nature of the acoustic channel, which also limits the communication bandwidth. Current narrowband approaches are limited by the frequency selectivity of the channel and achieve maximum data rates of up to 5 Mbps.

The U.S. Navy has expressed interest in deploying wireless sensing and control networks onboard their ships to maintain critical automated ship operations. Brooks, Lee, and Chen, “Smart Wireless Machinery Monitoring and Control for Naval Vessels,” Thirteenth International Ship Control Systems Symposium (SCSS), April, 2003; Hoover, Sarkady, Cameron, and Whitesel, “A Bluetooth-based Wireless Network for Distributed Shipboard Monitoring and Control Systems,” Proceedings of the 57^{th} Meeting of the Society for Machinery Failure Prevention Technology, April, 2003; Mokole, Parent, Street, and Thomas, “RF Propagation on Ex-USS Shadwell,” 2000 IEEE-APS Conference on Antennas and Propagation for Wireless Communications, 2000; Primerano, Kam, and Dandekar, “High Bit Rate Ultrasonic Communication Through Metal Channels,” Information Sciences and Systems, 2009; Seman, Donnelly, and Mastro, “Wireless Systems Development for Distributed Machinery Monitoring and Control,” Proceedings of the 2007 ASNE Intelligent Ships Symposium VII, 2007. The primary challenge of deploying such wireless networks is the structure of the ship hull—metallic walls obstruct electromagnetic wave propagation and limit network connectivity. Kevan, “Shipboard Machine Monitoring for Predictive Maintenance,” Sensors Magazine, Feb. 1, 2006. Passing cables through the bulkheads compromises the structural integrity of the ship's watertight compartments. Ultrasonic signaling has been investigated as an alternative method to augment the isolated RF wireless networks and achieve more dependable coverage without mechanically penetrating the bulkhead. Hu, Zhang, Yang, and Jiang, “Transmitting Electric Energy through a Metal Wall by Acoustic Waves using Piezoelectric Transducers,” IEEE Transactions on Ultrasonics, Ferroelectrics, and Frequency Control,” June, 2003; Wanuga, Dorsey, Primerano, and Dandekar, “Hybrid Ultrasonic and Wireless Networks for Naval Control Applications,” Proceedings of the 2007 ASNE Intelligent Ships Symposium VII, 2007.

Nonetheless, the unique acoustic qualities of the ultrasonic channel induce echo effects that cause large delay spreads. The resulting highly frequency selective, reverberant nature of the channel restricts its coherence bandwidth and causes the ultrasonic through-metal link to become a network throughput bottleneck. Murphy, “Ultrasonic Digital Communication System for a Steel Wall Multipath Channel: Methods and Results,” Master's Thesis, RPI, 2006. Current narrowband approaches of ultrasonic signaling limited by the frequency selective nature of the channel require the use of high complexity equalizers to improve throughput. The existing ultrasonic communications systems found in literature achieve maximum throughput rates of up to 5 Mbps. Graham, Neasham, and Sharif, “High Bit Rate Communication through Metallic Structures using Electromagnetic Acoustic Transducers,” OCEANS 2009-EUROPE 2009, May 11-14, 2009; Primerano, Kam, and Dandekar, “High Bit Rate Ultrasonic Communication Through Metal Channels,” Information Sciences and Systems, 2009. Techniques for providing improved data rates in such environments are desirable.

Previous work by the present inventors has demonstrated that an OFDM-based system is capable of achieving high data rate communication through metal walls while mitigating the frequency selectivity of the ultrasonic channel without the need for complex analyzers. For example, see Bielinski, “Application of Adaptive OFDM Bit Loading for High Data Rate Through-Metal Communication,” IEEE Global Telecommunications Conference, 2011, and Bielinski, “High Data Rate Adaptive Ultrasonic OFDM Physical Layer for Through-Metal Communications,” Proceedings of the 2011 ASNE Intelligent Ships Symposium IX, 2011. OFDM is a modulation technique used to mitigate severe frequency selectivity in wideband channels that does not require the use of highly complex equalizers. However, a disadvantage of OFDM is the high peak-to-average power ratio (PAPR) which can result in non-linear modulation distortion, out of band radiation, and reduced transmission range due to high signal peaks. These peaks in signal power come from the nature of OFDM; the N independent subcarriers add up in phase, creating signal peaks that can be up to N times larger than the average power. A large amount of research has been devoted to the reduction of signal peaks. For example, see Li and Cimini Jr, “Effects of Clipping and Filtering on the Performance of OFDM”, IEEE Vehicular Technology Conference, August, 2002; Popovic, “Synthesis of Power Efficient Multitone Signals with Flat Amplitude Spectrum”, IEEE Transactions on Communications, July, 1991; Tarokh and Jafarkhani, “On the Computation of the Peak to Average Power Ratio in Multicarrier Communications,” IEEE Transactions on Communications, 2000; Wade, Eetvelt, and Tomlinson, “Peak to Average power Reduction for OFDM Schemes by Selective Scrambling,” IEEE Electronic Letters, October, 1996; and Wilkinson, Jones, and Barton, “Block Coding Scheme for Reduction of Peak to Mean Envelope Power Ratio of Multicarrier Transmission Schemes,” IEEE Electronic Letters, December, 1994. Also, Tan and Bar-Ness in “OFDM Peak-to-average Power Ratio Reduction by Combined Symbol Rotation and Inversion with Limited Complexity,” IEEE Global Telecommunications Conference, 2003, describe an OFDM signal rotation and inversion algorithm for reducing signal peaks. However, none of these approaches implements an approach that is tailored for the ultrasonic framework or that addresses the reduced effective transmit power due to inefficient use of the power amplifiers.

An approach is desired that is adapted to an OFDM-based framework with reduced PAPR while maximizing throughput and probabilistically constraining symbol estimation error. The present invention has been designed to address these needs in the art.

### SUMMARY

An adaptive OFDM transceiver was designed for an ultrasound channel to allow for wireless transmission through metal walls to avoid physically penetrating them and compromising structural integrity. This ultrasound transceiver achieves higher data rates by exploiting and combining the benefits of subcarrier-based rate adaptation using an adaptive bit loading (ABL) algorithm and peak to average power ratio (PAPR) reduction through frequency domain symbol rotation using a PAPR reduction algorithm. Reduction of PAPR makes more efficient use of the power amplifiers in the system, where adaptive bit loading achieves greater spectral efficiency. The ultrasound transceivers provide high data rates using wireless communication techniques in environments where metallic structures impede RF signal propagation. The application of reducing PAPR prior to adaptive bit loading has the added benefit of efficient power amplifier use for increased transmit power to allow for more information to be transmitted while adhering to a reliability constraint. The dependence of high PAPR for the increased number of frequency subcarriers typically employed in this medium makes this approach highly advantageous. The two algorithms together function to maximize throughput while constraining the probability of symbol estimation error.

Orthogonal Frequency Division Multiplexing (OFDM) has been shown to be a promising technique to mitigate the frequency selectivity of the ultrasonic channel without the need for complex equalizers. The invention improves the link adaptive OFDM ultrasound physical layer and further enriches through-metal communications by exploiting the slow-varying nature of the ultrasonic channel and employing a combined rate adaptive and Peak-to-Average Power Ratio (PAPR) reduction algorithm. In particular, reduction of PAPR is obtained by rotating data symbols in the frequency domain to make more efficient use of the power amplifiers in the system. The addition of adaptive bit loading achieves greater spectral efficiency and increases data rates. A joint algorithm employing adaptive bit loading and reduced PAPR has been shown to simultaneously increase throughput rates, reduce PAPR, and adhere to bit error rate (BER) constraints, thus providing the throughput and reliability needed to support high data rate control network applications.

In an exemplary embodiment, an OFDM-based link adaptive ultrasonic physical layer is provided that is capable of achieving high data rate communication through metal walls. OFDM is a common technique used to mitigate the severe frequency selectivity of wideband channels without requiring high complexity equalizers. OFDM is used in accordance with the invention to divide the frequency selective channel into orthogonal flat fading bands. The static nature of the ultrasonic channel also allows for the ability to maintain accurate channel state information over a long duration of time and therefore provides the opportunity to adapt to measured channel conditions with limited overhead. An OFDM subcarrier-based rate adaptive modulation algorithm is used to maximize throughput while probabilistically constraining symbol estimation error. Since PAPR reduction and ABL complement one another, reducing the PAPR allows for more efficient use of the power amplifiers and dynamic range of the digital-to-analog converters (D/A) to result in higher transmitted data rates for the same Bit Error Rate (BER) constraint. Further, the stationary nature of the ultrasonic channel allows for maintenance of the channel state information (CSI) required for rate adaptation. The CSI remains accurate over a long duration of time and therefore provides an environment for adaptation to channel conditions with limited overhead. Implementation of the joint adaptive algorithm in the ultrasonic channel has demonstrated transmitted throughput rates of up to 11 Mbps while maintaining a BER of 10⁻⁵ at low transmit powers and reducing PAPR by up to 2 dB. This performance constitutes data rate improvements of up to 220% when compared to current narrowband ultrasonic links reported in the literature, thus improving the throughput and reliability needed to support high rate network applications such as below decks on navy vessels.

The methods of the invention include using OFDM to divide a frequency selective wideband channel into orthogonal frequency flat fading sub-channels. The flat fading allows reduced complexity equalization and their orthogonality allows each sub-channel to be treated independently and adapted to the conditions of that sub-channel. The stable nature of the acoustic channel is exploited by feeding back channel state information (estimated at the receiver) to the transmitter. This feedback allows the transmitter to adapt transmission parameters to improve spectral efficiency, increase system reliability, and adjust to changing wireless conditions with reduced overhead. More specifically, channel state information is used for adaptive bit loading, which allows maximization of the throughput for an OFDM transmission while constraining the maximum occurrence of transmission error probabilistically. The methods of the invention thus permit the use of channel state information by feedback and link adaptive bit loading (ABL) to improve spectral efficiency while achieving higher throughput and better link reliability. The methods of the invention also provide network designers an additional degree of control to balance system throughput with probability of transmission error.

In an exemplary embodiment of the invention, a system is provided for communicating data through metal. The system includes first and second acoustic transducers on opposing sides of the metal, a data modulator on the transmission side, and a signal processor and demodulator on the receiving side. The data modulator modulates data bits onto subcarriers using rate adaptive orthogonal frequency division multiplexing modulation whereby transmission parameters for the modulated data are adapted based on feedback of channel state information of sub-channels for improving spectral efficiency and reliability of the sub-channels during transmission through the metal. The modulated data bits are applied to the first acoustic transducer for transmission of the data through the metal on the sub-carriers. The second acoustic transducer receives OFDM symbols that have been transmitted through the metal sub-channels. The signal processor then equalizes the received OFDM symbols using the channel state information applied to each subcarrier, and the demodulator demodulates the data bits from the received sub-carriers.

In a first exemplary embodiment, the data modulator applies an adaptive bit loading algorithm to the data bits so as to maximize a number of bits per OFDM symbol under a fixed energy and bit error rate constraint. In a second exemplary embodiment, a data processing block is further provided that additionally implements a peak-to-average power ratio (PAPR) reduction algorithm to reduce the PAPR of the subcarriers by rotating and/or inverting symbols to find sequences with reduced PAPR after the rotating and/or inverting. The information needed to achieve the minimum PAPR at each frame sub-block is stored in a memory and sent to the receiver for use in recovering the modulated data bits prior to demodulation at the receiver. In the exemplary embodiments, the data modulator further quadrature amplitude modulates 512 orthogonal subcarriers spaced at approximately 10 kHz intervals with the data bits. The selection of 512 subcarriers was made such that each subcarrier can be viewed as an independent, flat-fading channel. In the exemplary embodiments, the signal processor may estimate the complex channel gain independently on each subcarrier from training symbols.

### BRIEF DESCRIPTION OF THE DRAWINGS

The foregoing and other beneficial features and advantages of the invention will become apparent from the following detailed description in connection with the attached figures, of which:

FIG. 1 illustrates a through-metal channel model for transmitting signals through a metal wall using acoustic transceivers in accordance with an embodiment of the invention.

FIG. 2 illustrates a frequency sweep of the frequency selective channel magnitude response for 0.25″ thick mild steel.

FIG. 3 illustrates a block diagram of an adaptive OFDM-based ultrasonic system in accordance with a first embodiment of the invention.

FIG. 4 illustrates the measured average bit error rate versus average post-processing signal-to-noise ratio performance for non-adaptive and rate-adaptive modulation in accordance with the first embodiment of the invention.

FIG. 5 illustrates the measured average transmitted data rate versus average post-processing signal-to-noise performance for non-adaptive and rate adaptive modulation in accordance with the first embodiment of the invention.

FIG. 6 illustrates the measured histogram of average bit allocation versus average post-processing signal-to-noise using an OFDM subcarrier-based rate adaptive modulation algorithm in accordance with the first embodiment of the invention.

FIG. 7 illustrates a block diagram of a joint adaptive OFDM-based ultrasonic system that incorporates adaptive bit loading and PAPR reduction in accordance with a second embodiment of the invention.

FIG. 8 illustrates successive selection of minimal PAPR on a block-by-block basis in the SS-CSRI algorithm of the invention.

FIG. 9 illustrates a comparison of successive minimal PAPR selections in SS-SCRI and Joint algorithms in accordance with the invention.

FIG. 10 illustrates simulated PAPR results using a joint adaptive bit loading and PAPR reduction algorithm in accordance with the second embodiment of the invention, where the three physical layers are implemented on top of the symbol rotation framework and compared for fixed rate Quadrature Phase Shift Keying (QPSK), Non-Power Scaled Rate Adaptive (NPSRA) bit-loading, and Power-Scaled Rate Adaptive (PSRA) bit-loading. The solid lines indicate the original PAPR for the QPSK, NPSRA, and PSRA data symbols prior to applying the symbol rotation algorithm, while the dotted lines represent the PAPR after employing symbol rotation for each physical layer.

FIG. 11 illustrates the ability of the techniques of the invention to adhere to a bit error rate (BER) constraint where the straight dotted line indicates the desired 10⁻⁵ BER target and the bit-loaded physical layers NPSRA and PSRA are capable of remaining below the BER threshold despite increases in the data rate at higher transmitted powers.

FIG. 12 illustrates that the techniques of the invention significantly increases the data rate in comparison to fixed-rate modulation schemes, such as QPSK, while adhering to a desired reliability (BER) constraint. As shown, the fixed-rate transmission can only achieve a maximum of roughly 5 Mbps, where the NPSRA and PSRA bit-loaded physical layers reach data rates of roughly 11 Mbps.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to methods and software for implementing such methods.

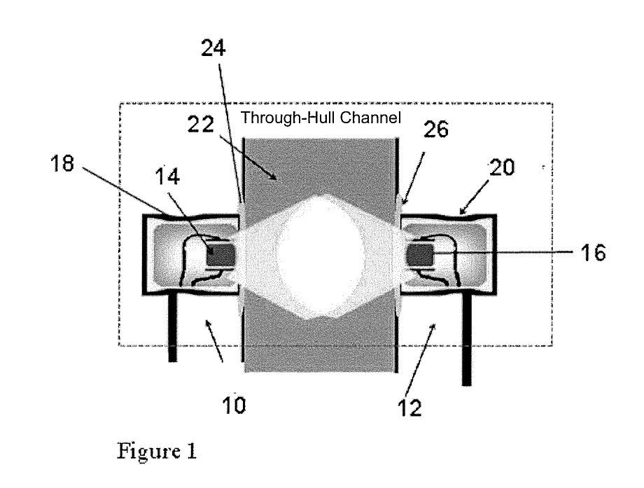

A detailed description of illustrative embodiments of the present invention will now be described with reference to FIGS. 1-12. Although this description provides a detailed example of possible implementations of the present invention, it should be noted that these details are intended to be exemplary and in no way delimit the scope of the invention.

### The Ultrasonic Channel

FIG. 1 illustrates a through-metal channel model for transmitting signals through a metal wall using acoustic transceivers 10, 12 having, for example, piezoelectric elements 14, 16 in transducer housings 18, 20 in accordance with an embodiment of the invention. In the illustrated embodiment, a signal generator (not shown), such as an Agilent N5182A MXG Vector Signal Generator, provides electrical signals to ultrasonic transducers 10, 12, such as Panametrics A112S-RM ultrasonic transducers, that convert electrical energy into acoustic energy and provide acoustic signals through a metal wall 22 (e.g., 0.25″ thick mild steel wall representative of a naval bulkhead). The initial baseband signals are generated by the signal generator and baseband processing is performed using, e.g., MATLAB software. Direct up-conversion of in-phase and quadrature signal components allows modulation of both the amplitude and phase of the carrier waveform. The acoustic signals that pass through the metal wall ultrasonically are received by a transducer on the opposite side of the wall through a coupled ultrasonic interface 24 or 26 as illustrated and then processed. The ultrasonic energy is captured at passband so that the signal may be down-converted to baseband in software. All final signal and data processing is performed, e.g., in MATLAB.

As illustrated in FIG. 1, data entering the transceiver 10 to the left of the metal bulkhead 22 is transmitted as ultrasonic energy through the metallic barrier. The data is received by the right-hand transceiver 12 and recovered through signal processing. The ultrasonic channel therefore consists of the ultrasonic transducers 10, 12 and the metal barrier 22 dividing them. The transducers are responsible for converting electrical energy into acoustic energy. Unfortunately, the transducer mating to the wall through coupled ultrasonic interfaces 24, 26 causes a mismatch in acoustic impedance due to differences in the materials making up the transducers 10, 12 and the wall 22. This impedance mismatch between the transducers 10, 12 and the barrier 22 causes reflections within the barrier 22.

It has been experimentally validated that the ultrasonic system of FIG. 1 is approximately linear with respect to an ensemble of rectangular pulse tests. See, for example, Primerano, Kam, and Dandekar, “High Bit Rate Ultrasonic Communication Through Metal Channels,” Information Sciences and Systems, 2009. The system can be modeled as a transient response consisting of a primary resonant pulse and a series of delayed echo paths. Impedance mismatch, diffraction, and transceiver misalignment are all responsible for the echoing that creates inter-symbol interference (ISI) when using high-rate narrowband modulation techniques.

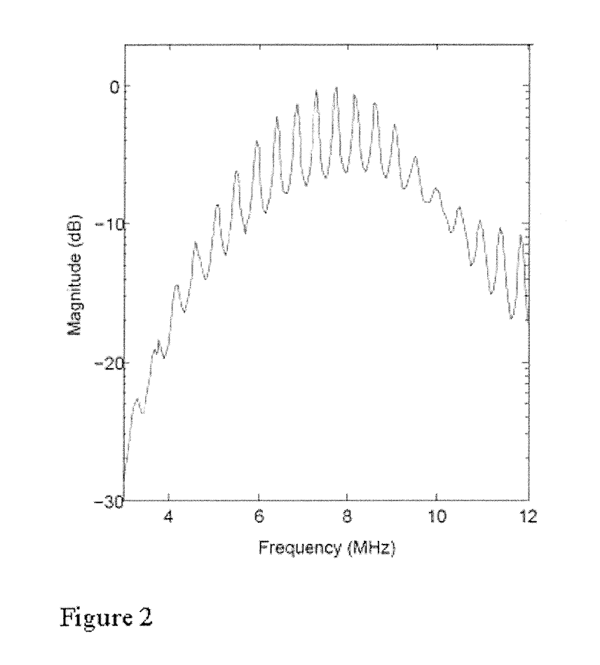

An experimentally measured frequency sweep of the frequency selective channel magnitude response for 0.25″ thick mild steel is shown in FIG. 2. The transducers 10, 12 are matched to the steel 22, with mismatch due to the junction between transducer 10, 12 and bulkhead 22. The reflection coefficient at this transducer-bulkhead junction is approximately −0.48. As illustrated in FIG. 2, deep nulls and high peaks occur within the response, i.e., it is highly frequency selective. The deep nulls within the response depicted in FIG. 2 are associated with the acoustic echoing present in the channel, where null-to-null spacing is equal to the reciprocal of the round trip echo period of the channel, which can be calculated from the physical thickness of the wall and the speed of sound in the steel 22. The adaptive OFDM-based physical layer described below is tailored to communicate through the ultrasonic channel. As will be shown, the proposed system is capable of counteracting the echo-induced channel distortion, reducing PAPR, and providing increased throughput and link reliability.

### Ultrasonic Physical Layer

### First Embodiment

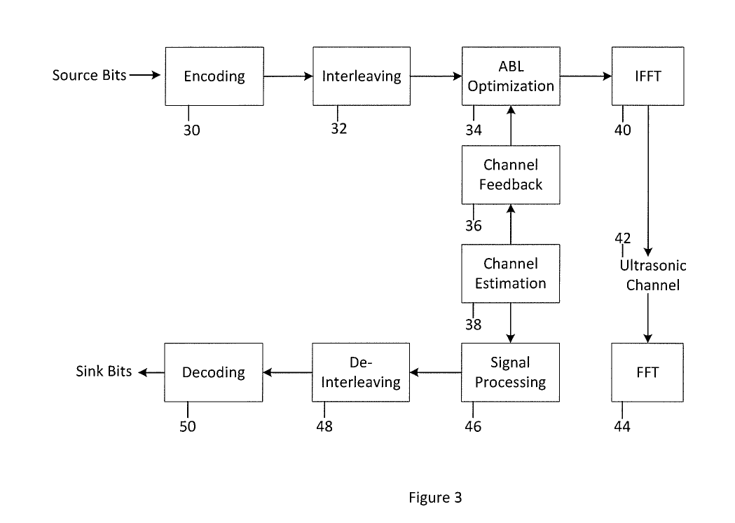

A block diagram of the adaptive OFDM-based ultrasonic system in accordance with a first embodiment of the invention is depicted in FIG. 3. As illustrated, the source bits are encoded at encoder 30, interleaved by interleaver 32, and appropriately modulated at the transmitter according to the bit distribution calculated by an adaptive bit loading (ABL) optimization algorithm 34 in accordance with the first embodiment of the invention. Adaptive Bit-Loading is the process by which data is allocated to the orthogonal sub-channels of the message based on fed back channel state information. The ABL algorithm assumes that there is correlation between the channels over successive transmissions. Further, an initial training transmission may be performed to acquire channel state information (CSI) at the receiver via channel feedback 36 from a channel estimator 38. For the ABL algorithm, this information is a size N vector of error vector magnitudes (EVM) for each subcarrier. It is assumed that the ABL algorithm exploits CSI through closed-loop feedback. After modulation, the information is converted to the time domain via an IFFT 40 and transmitted over the ultrasonic channel 42. Upon reception, the data is converted back to the frequency domain via FFT 44, equalized and demodulated by signal processor 46, de-interleaved by de-interleaver 48, and decoded by a decoder 50 at the receiver.

In an exemplary embodiment, the ultrasonic physical layer makes use of a 512 subcarrier OFDM frame over a 5 MHz bandwidth to mitigate the severe frequency selectivity and limited coherence bandwidth of the channel. Subcarriers are spaced by approximately 10 kHz of bandwidth to assure that a flat fading channel may be assumed for each subcarrier. The link ABL scheme performed on each subcarrier is also implemented to improve spectral efficiency of the link. The goal of the ABL algorithm is to maximize link throughput constrained by a target bit error rate (BER). The exemplary embodiment of the ABL algorithm has shown achievable average transmitted data rates of 15 Mbps for average Peak Power Signal-to-Noise (PPSNR) values in the range of 22-24 dB.

### Orthogonal Frequency—Division Multiplexing

The adaptive OFDM-based ultrasonic system illustrated in FIG. 3 uses a direct up/down conversion front-end to exploit in-phase and quadrature components of the carrier and allows for adaptive multi-level quadrature amplitude modulation (QAM). In an exemplary embodiment, the baseband signal to be transmitted is constructed with 512 orthogonal subcarriers, 496 of which carry data symbols. Non-data-carrying subcarriers include 6 pilot tones for correcting residual carrier frequency offset (CFO) and clock drift and 10 carriers reserved as a guard band to avoid interference from carrier energy. Adaptive constellation orders for each subcarrier range between M-QAM, and the algorithm allows each subcarrier to utilize M-QAM modulation, where M=2ⁱ, i={2, 4, 6, 8, 10, 12, 14}. This approach provides packet information rates between 496 to 6944 un-coded bits per OFDM symbol. The symbols are transmitted at a rate of 7.81 kSymbols/s over an effective 5 MHz bandwidth centered at 8.3 MHz.

Each of the 512 subcarriers is viewed as its own flat fading channel under OFDM, and therefore, can be mathematically modeled by:

yₖ=\sqrt{eₖ}hₖxₖ+nₖ 1≦k≦N (1)

where eₖ is the power associated with the k^{th} subcarrier, hₖ and xₖ are the k^{th} subcarrier channel response and transmitted symbol, respectively, and nₖ˜η(0,σₙ) is the additive white Gaussian noise (AWGN) of the k^{th} subcarrier. Noise is assumed to have zero mean and unit variance. The resulting system for all loaded subcarriers can also be expressed as a vector channel matrix of length N.

The receiver estimates the complex channel gain independently on each subcarrier from training symbols as shown in Equation (2):

$${\hat{h}}_{k} = \frac{{y}_{k}}{{x}_{k}} = {h}_{{Tr}_{k}} + \frac{{n}_{{Tr}_{k}}}{\sqrt{{e}_{k}} {x}_{{Tr}_{k}}} 1 \leq k \leq N \qquad ( 2 )$$

In Equation (2), h_{Trk} is the training channel, x_{Trk} is the k^{th} known training symbol, and n_{Trk} is the k^{th} subcarrier AWGN noise factor. The sample mean of two training symbols is used as the unbiased estimator of channel gain. Received OFDM symbols are corrected through zero-forcing equalization from the measured channel estimates as shown in Equation (3), where ĥₖ and ̂xₖ are respectively the kth subcarrier estimated channel response and estimated transmitted symbol:

$${\hat{x}}_{k} = \frac{{y}_{k}}{{\hat{h}}_{k}} = \frac{\sqrt{{e}_{k}} {h}_{k} {x}_{k}}{{\hat{h}}_{k}} + \frac{{n}_{{Tr}_{k}}}{{\hat{h}}_{k}} 1 \leq k \leq N \qquad ( 3 )$$

It should be noted that symbol estimation has two factors affecting EVM, primarily initial channel estimation error and the presence of noise. This is shown in Equation (3), where yₖ is the k^{th} received symbol consisting of the current transmission channel, hₖ, the power associated with the k^{th} subcarrier, eₖ, and the k^{th} transmitted symbol and AWGN factor, xₖ and nₖ, respectively.

Finally, pilot subcarriers are used to correct residual CFO over the duration of the packet due to clock drift.

Adaptive Bit Loading

Adaptive, subcarrier-based bit loading algorithms previously developed by Chow, Cioffi, and Bingham, “A Practical Discrete Multitone Transceiver Loading Algorithm for Data Transmission Over Spectrally Shaped Channels,” IEEE Transactions on Communications, 1995, attempt to maximize the number of bits per OFDM symbol under a fixed energy and BER constraint and are based on the “SNR gap” concept. The SNR gap is an estimate of the additional power necessary for transmission using discrete constellations when compared to capacity-achieving Gaussian codebooks as described by Toumpakaris and Lee, “On the Use of the Gap Approximation for the Gaussian Broadcast Channel,” IEEE Global Telecommunications Conference, 2010. The gap concept also relates the receiver SNR to a desired symbol error rate under the assumption of equally probable messages. The ultrasonic OFDM ABL algorithm used in accordance with the first embodiment of the invention is based on the statistical evaluation of the received symbol distribution as described by the EVM and also considers the relationship between bit error probability and SNR.

Additional bit loading algorithms created by Campello in “Optimal Discrete Bit Loading for Multicarrier Modulation Systems,” Information Theory (1998), strive to calculate bit distributions that are “energy-tight,” meaning that no other bit distribution can be calculated across all subcarriers such that an equivalent number of bits can be loaded with less average energy within the individual symbols. In contrast to these power-scaled rate adaptive algorithms, the non-power-scaled ABL algorithm implemented in accordance with the first embodiment of the invention does not “tighten” the energy within the individual subcarriers. Rather, it assumes an average unit power.

The rate adaptive bit loading algorithm described by Chow, Cioffi, and Bingham (1995) attempts to maximize the number of bits per OFDM symbol under a fixed energy and BER constraint using equations (4) and (5) below. The number of subcarriers is denoted by N, where εₖ and gₖ are the k^{th} subcarrier energy and gain, respectively, Γ is the SNR gap, and \acute{ε}ₓ is the average energy per dimension for the signal constellation x (Chow, Cioffi, and Bingham 1995; see also Cioffi, “Lecture Notes for Advanced Digital Communications” 2008).

$$\begin{matrix}{max}_{{ɛ}_{k}} b = {\sum }_{k = 1}^{N} \frac{1}{2} {log}_{2} ( 1 + \frac{{ɛ}_{k} {g}_{k}}{Γ} ) & ( 4 ) \\ s . t . \text{:} N {ɛ}_{x}^{′} = {\sum }_{k = 1}^{N} {ɛ}_{k} & ( 5 )\end{matrix}$$

The ultrasonic OFDM ABL algorithm of the first embodiment of the invention considers the relationship between the received SNR and the bit error probability of gray-coded, rectangular M-QAM modulation. Therefore, equations for SNR as a function of a given probability of error and even M-QAM modulation orders were formulated to generate an offline look-up table containing the linearly-scaled SNR values required to achieve BERs in the range of 10⁻⁴ to 10⁻⁶ for seven modulation rates. Modulation order decisions performed by the ABL algorithm are determined using an estimate of the subcarrier-based SNR values. These estimates utilize the EVM of the training transmission as their metric. Based on the subcarrier-based SNR calculation and the information available in the look-up table, the optimal distribution of bits among the subcarriers is allocated. Lastly, if the SNR for the kth subcarrier is less than that required for QPSK, BPSK is selected as the default modulation order.

A. Power-scaled Rate-Adaptive Bit Loading

Similar to previously implemented bit loading algorithms created by Campello as described in “Optimal discrete bit loading for multicarrier modulation systems,” IEEE International Symposium on Information Theory, p. 193, August 1998, the power-scaled rate adaptive algorithm strives to calculate bit distributions that are e-tight, meaning that no other bit distribution can be calculated across all subcarriers that reduces the average energy of the individual symbols (Ē) while loading an equivalent number of bits. The general algorithm used to perform power-scaled rate-adaption on a subcarrier basis for modulation orders that are strictly even powers of two is described as follows:

1) Compute the PPSNRₖ for each of the N subcarriers with average unit power based on:

$$\begin{matrix}{PPSNR}_{k} = \frac{1}{\overline{{EVM}_{k }}} 1 \leq k \leq N where & ( 6 ) \\ {EVM}_{k} = \overline{{\vert {x}_{k} - \vert}^{2}} 1 \leq k \leq N & ( 7 )\end{matrix}$$

and xₖ is the transmitted signal and [symbol] is the received signal.
2) Let bₖ be the number of bits loaded in subcarrier k, Eₖ the total energy used by subcarrier k, eₖ the energy required to increment the bit distribution in subcarrier k, and Bₜₒₜₐₗ the total number of bits loaded among all carriers. Initialize all values to 0.

3) While the total energy used by all subcarriers:

$${E}^{tot} = {\sum }_{k = 1}^{N} {E}_{k} < N \overline{{ɛ}_{k}} \qquad ( 8 )$$

of Equation (5), find the incremental energy eₖ, to load 2 additional bits at the estimated SNR for each subcarrier.

4) Find:

e^{load}=min(e), (9)

the minimum energy required to load two additional bits among the N subcarriers.

5) Load the additional 2 bits on this subcarrier and increment the total number of bits and the total energy used by the subcarrier being loaded so that

B^{total}=B^{total}+2 (10)

E^{load}=E^{load}+e^{load} (11)
6) Upon utilizing all available energy, scale each subcarrier according to its calculated total energy.

B. Non-Power-Scaled Rate Adaptive Bit Loading

In contrast to the power-scaled rate adaptive algorithm, the non-power-scaled rate adaptive algorithm does not “tighten” the energy within the individual subcarriers. Rather, it assumes average unit power for all subcarriers. Although suboptimal, this algorithm is much simpler in implementation and can actually reduce the potential of decoding errors due over long time intervals when training is not performed. This is due to the fact that scaling power according to stale channel state information tends to have a greater effect on BER than selecting suboptimal or inaccurate bit distributions.

The general algorithm to perform the non-power-scaled rate-adaption on the subcarrier basis for modulation orders that are strictly even powers of two is described as follows:

1) Compute the PPSNRₖ for each of the N subcarriers with average unit power based on Equation (6).

2) Let bₖ be the number of bits loaded in subcarrier k and initialize to 0.
3) Let SNR^{M-QAM} denote the SNR required to achieve M-QAM modulation while meeting the desired BER constraint.

4) For each subcarrier, determine the largest M such that:

PPSNRₖ<SNR^{M-QAM} and set bₖ=log₂(M).

### Results

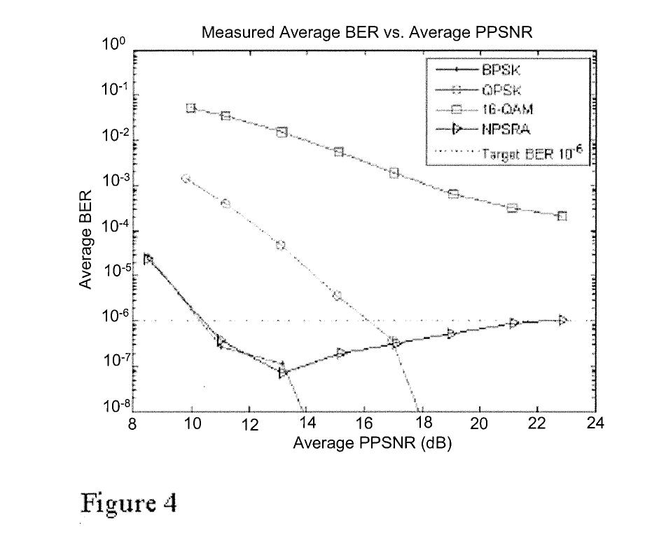

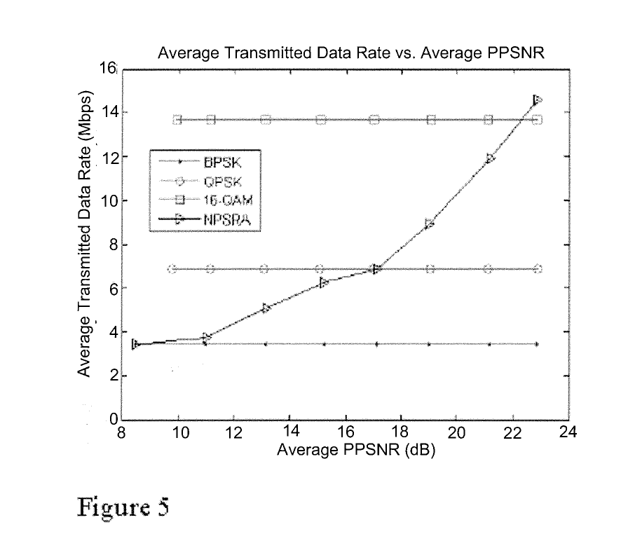

A comparison was made between three fixed-rate modulations and the OFDM-based non-power-scaled rate adaptive (NPSRA) physical layer of the embodiment of FIG. 3. First, fixed-rate BPSK, QPSK, and 16-QAM packets were transmitted consecutively to acquire an estimate of the EVM for each individual subcarrier Immediately following these packets, the non-power-scaled ABL algorithm calculated the optimal bit distribution according to the mean EVM of the three previous fixed-rate packets. For each modulation rate, a total of 6000 packets composed of 30 OFDM data symbols were transmitted during measurements. The mean BER and mean transmitted data rates for a strict target BER of 10⁻⁶ were collected and plotted in FIG. 4 and FIG. 5, respectively, over an average channel PPSNR range of 8 dB to 24 dB.

Upon viewing the measured results in FIG. 4, it is apparent that the ABL algorithm successfully adheres to the target BER even at lower PPSNR values of roughly 11 dB, unlike the high-rate non-adaptive techniques. Fixed-rate QPSK requires a PPSNR of 16 dB or higher to achieve the BER constraint, while 16-QAM modulation never obtains average BERs of 10⁻⁶ over the measured average PPSNR range. Note that the average BER for this modulation rate was always measured to be larger than 10⁻⁴. These increased error rates for higher-order modulation are an effect of the significant frequency selectivity that occurs in the ultrasonic channel and results in inter-symbol interference (ISI).

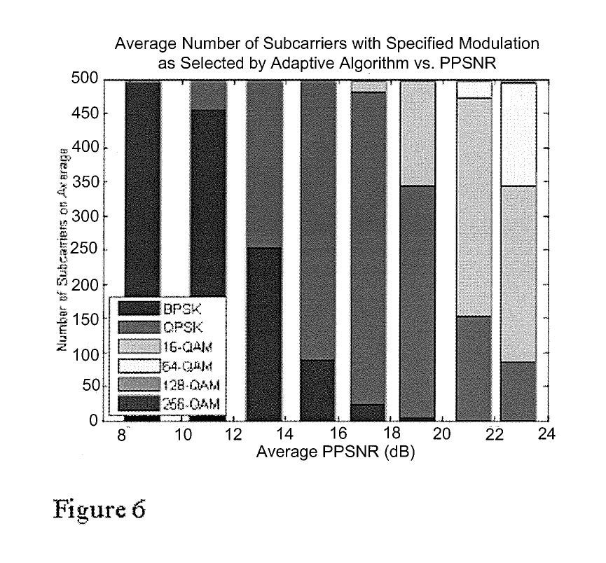

From FIG. 5, it is also clear that adaptive modulation achieves larger average transmitted data rates in comparison to fixed M-QAM modulation. The ability of the ABL algorithm to significantly improve throughput is explained primarily by the fact that bit-loading exploits higher-quality subcarriers while transmitting fewer bits on weaker subcarriers. The ABL algorithm of the first embodiment of the invention is capable of maintaining a desired level of reliability while maximizing throughput by using hybrid modulations. This ability of the adaptive OFDM physical layer to optimize data rates based on measured channel conditions is depicted in FIG. 6, which provides a histogram of the average number of subcarriers utilizing a specific modulation rate with respect to a measured average PPSNR.

As shown in FIG. 6, a large number of subcarriers is loaded with only a single bit when channel conditions are poor. For larger average PPSNR values, the OFDM-based NPSRA physical layer is capable of loading up to 6 bits, i.e. utilizing 64-QAM, while still maintaining the desired BER despite that fixed-rate 16-QAM still experiences insufficient error rates at these average PPSNR values.

For an average measured PPSNR of 22.8 dB, FIG. 6 indicates that for a BER constraint of 10⁻⁶, 151 subcarriers can load 64-QAM, 257 carriers can utilize 16-QAM, 86 carriers load QPSK, and the remaining subcarriers only support BPSK modulation. This spread of data rates among the subcarriers provides a clear visual of how the proposed adaptive physical layer takes advantage of high-quality subcarriers to further improve spectral efficiency in the ultrasonic channel.

Although narrowband modulation techniques are not directly compared in FIG. 4 or FIG. 5, use of OFDM and M-QAM modulation in the ultrasonic channel alone can increase data rates above the maximum 5 Mbps achievable using narrowband techniques, as noted by Primerano, Kam, and Dandekar 2009. In fact, 16-QAM is capable of increasing throughput by 36% when considering that an average transmitted data rate of roughly 6.8 Mbps can be obtained while still meeting the desired 10⁻⁶ BER constraint above average PPSNR values of roughly 16 dB. Use of the rate adaptive physical layer further increases the average transmitted data rate to roughly 14.6 Mbps at the average PPSNR values of 22-24 dB. With respect to narrowband techniques, this is a significant improvement of approximately 300%.

### Joint Adaptive OFDM Communication Algorithm

### Second Embodiment

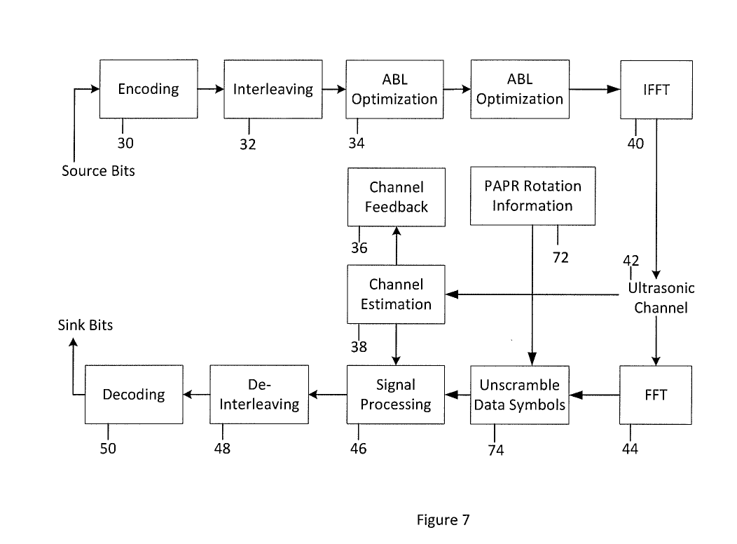

FIG. 7 illustrates a block diagram of a joint adaptive OFDM-based ultrasonic system that incorporates adaptive bit loading and PAPR reduction in accordance with a second embodiment of the invention. As in the embodiment of FIG. 3, the source data bits are encoded at encoder 30, interleaved by interleaver 32, and appropriately modulated at the transmitter according to the bit distribution calculated by an adaptive bit loading (ABL) optimization algorithm 34. The rate adaptive algorithm requires channel feedback, relying on the assumption that the transmission channel remains stationary over a minimum duration of two packets. As in the first embodiment, an initial training transmission may be performed to acquire channel state information (CSI) at the receiver via channel feedback 36 from a channel estimator 38. For the ABL algorithm, this channel state information is a size N array of error vector magnitudes (EVM) for each of the N subcarriers. It is assumed that the CSI is accessible to the transmitter.

After modulation, the information is converted to the time domain via an IFFT 40 and transmitted over the ultrasonic channel 42. Upon reception, the data is converted back to the frequency domain via FFT 44, equalized and demodulated by signal processor 46, de-interleaved by de-interleaver 48, and decoded by a decoder 50 at the receiver. However, in this embodiment, after modulation, the PAPR is reduced through a symbol rotation and inversion algorithm 70 like that described by Tan and Bar-Ness (2003) that finds the sequences whose PAPR is lowest upon permutation in the frequency domain. Information regarding the number of rotations and inversions necessary to achieve the minimum PAPR at each frame sub-block is stored and sent to the receiver as shown in the “PAPR Rotation Information” block 72 in FIG. 7. This information is used to recover the original data sequence at 74 prior to demodulation at the receiver.

The joint algorithm of this embodiment is implemented to make more efficient use of the power amplifiers in the system and to improve spectral efficiency of the link while constrained by a target bit error rate (BER). The embodiment of FIG. 7 has shown achievable average transmitted data rates of 11 Mbps for average transmit power values in the range of 6-7 dBm.

### Orthogonal Frequency—Division Multiplexing

As in the embodiment of FIG. 3, the embodiment of FIG. 7 contains a 512 subcarrier OFDM frame spread over a 5 MHz bandwidth to mitigate the severe frequency selectivity and limited coherence bandwidth of the channel. The subcarriers are spaced by approximately 10 kHz of bandwidth, ensuring that a flat fading channel may be assumed for each subcarrier. As in the embodiment of FIG. 3, direct up/down conversion is again performed at the front-end to exploit in-phase and quadrature components of the carrier and to allow for adaptive multi-level quadrature amplitude modulation (QAM). The transmitted baseband signal is composed of the 512 orthogonal subcarriers, 496 of which carry data symbols. Non-data-carrying subcarriers include 6 pilot tones for correcting clock drift and residual carrier frequency offset (CFO) and 10 carriers reserved as a guard band to avoid interfering with energy from the carrier centered at 8.3 MHz. Constellation orders for the adaptive algorithm allow each subcarrier to range between M-QAM, where M=2i, i={2, 4, 6, 8, 10}. The symbols are transmitted at a rate of 7.81 kSymbols/s over an effective 5 MHz bandwidth.

### PAPR Reduction

Peak to average power ratio (PAPR) is a major disadvantage of OFDM systems and can lead to a number of issues that consequently decrease system performance. The PAPR is dependent on the number of subcarriers in the OFDM system—a larger number of subcarriers will increase the magnitude of the PAPR. To avoid high PAPR and to take full advantage of the power amplifiers in the system of FIG. 7, symbol rotation algorithms proposed in Tan and Bar-Ness in “OFDM Peak-to-average Power Ratio Reduction by Combined Symbol Rotation and Inversion with Limited Complexity,” IEEE Global Telecommunications Conference, 2003, are adapted to the ultrasonic environment (which, with 512 subcarriers, has an increased sensitivity to PAPR) in accordance with the second embodiment of the invention. Although an optimal approach is available, suboptimal approaches can still significantly reduce PAPR with the added benefit of reduced complexity in comparison to the optimal approach.

The Optimal Combined Symbol Rotation and Inversion (O-CSRI) algorithm in accordance with the invention considers a set of N complex symbols, Xᵢ, in an N subcarrier OFDM communication system, where pilot symbols are not permuted (Tan and Bar-Ness, 2003). The sequence of symbols is divided into M blocks, each with N/M elements, where the ratio is an integer. The i^{th} block can then be defined as Bᵢ=[X_{i,1}, X_{i,2}, . . . , X_{i, N/M}]. Within each of these M blocks, the N/M symbols are rotated to generate at most N/M blocks:

$${B}_{i}^{’ ( 1 )} = [ {X}_{i , 1} , {X}_{i , 2} , … , {X}_{i , N / M} ] , \\ {B}_{i}^{’ ( 2 )} = [ {X}_{i , N / M} , {X}_{i , 1} , … , {X}_{i , ( N / M ) - 1} ] , \\ … , \\ {B}_{i}^{’ ( N / M )} = [ {X}_{i , 2} , {X}_{i , 3} , … , {X}_{i , 1} ] . \qquad ( 12 )$$

To avoid having the same symbols occur in one OFDM block, another set of N/M blocks are also created by inverting the first N/M blocks, B^{(j)}, for a combined total of 2N/M blocks:

$${\underline{B}}_{i}^{’ ( 1 )} = - {B}_{i}^{’ ( 1 )} , \\ {\underline{B}}_{i}^{’ ( 2 )} = - {B}_{i}^{’ ( 2 )} , \\ … , \\ {\underline{B}}_{i}^{’ ( N / M )} = {B}_{i}^{’ ( N / M )} . \qquad ( 13 )$$

Thus, a length N OFDM sequence divided into M blocks will have a maximum of (2N/M)^{M} unique combinations. The combination of symbols with the smallest PAPR is then selected for transmission, along with the side information regarding the number of rotations and inversions required to achieve this minimal PAPR. The side information is necessary to recover the original OFDM sequence at the receiver and requires M log₂(2N/M) bits.

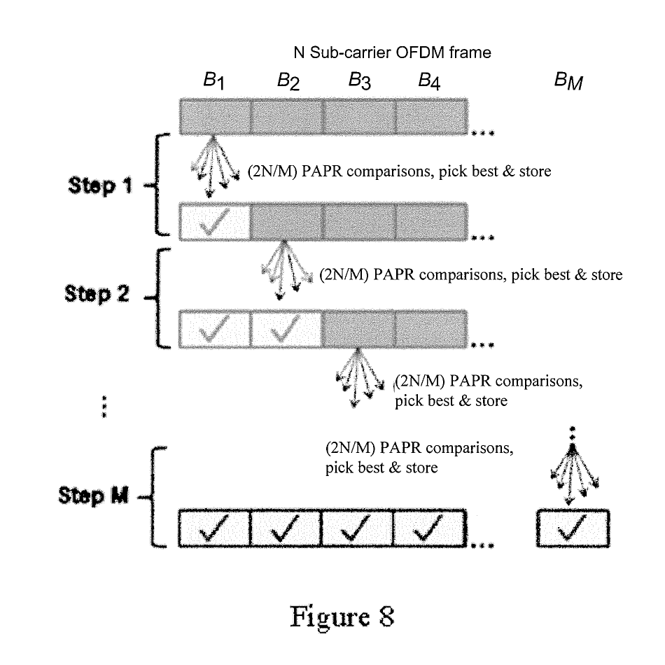

In the suboptimal approach, named the Successive Suboptimal Combine Symbol Rotation and Inversion (SS-CSRI) algorithm, in contrast to the O-SCRI implementation, the minimal PAPR is found successively—the random permutations are performed within each individual block (while keeping the other blocks the same) rather than performing permutations of all blocks. Therefore, the N complex symbols are first divided into blocks of N/M elements, as was done in the optimal approach. Next, symbol rotation and inversion is performed on only the first of M blocks for a total of 2N/M sequences. The combination with the smallest PAPR in the first block is stored in storage 72 (FIG. 7) for each block without consideration of the remaining M−1 blocks. This process continues for each of the remaining M−1 blocks, resulting in a total of 2N inversions, as shown in FIG. 8.

In the optimal approach (O-SCRI), the number of possible sequences grows exponentially with N, assuming that the number of symbols in each block is constant. Thus, for large M, a significant number of comparisons are needed to locate the sequence with minimal PAPR. Complexity becomes prohibitively high and makes this approach impractical. However, in the suboptimal algorithm (SS-CSRI), the total number of combinations is limited to 2N. Although the search space for the minimal PAPR is significantly reduced, the suboptimal algorithm still offers high performance. Table 1 demonstrates the complexity reduction achieved by using the suboptimal approach when N=512 subcarriers and M=16 blocks are considered.

TABLE 1
Comparison of Optimal and Suboptimal
PAPR Reduction Algorithm Complexity

| O-SCRI (Optimal) | SS-SCRI (Suboptimal) |
|---|---|
| $\underbrace{( \frac{2 N}{M} ) ( \frac{2 N}{M} ) ⋯ ( \frac{2 N}{M} )}_{M} = {( \frac{2 N}{M} )}^{M}$ | $\underbrace{( \frac{2 N}{M} ) + ( \frac{2 N}{M} ) - ⋯ - ( \frac{2 N}{M} )}_{M} = 2 N$ |
| ≈ 7.93 × 10²⁸ | ≈ 1024 |
| Combinations Total | Combinations Total |

Despite the reduction of permutations performed by the suboptimal algorithm, the amount of side information necessary to decode the original OFDM sequence at the receiver is the same as that in the optimal approach—M log₂(2N/M) bits. This is because the number of times the symbols were rotated (as well as whether they were inverted or not) needs to be conveyed.

### Adaptive Bit Loading

As in the first embodiment above, a rate adaptive bit loading algorithm given by Chow, Cioffi, and Bingham (1995) attempts to maximize the number of bits per OFDM symbol under a fixed energy and BER constraint. As above, this algorithm is based on the “SNR gap” that relates the receiver SNR to a desired symbol error rate under the assumption of equally probable messages. The ultrasonic OFDM bit loading algorithm implemented here is based on the statistical evaluation of the received symbol distribution as it is described by the EVM. The ultrasonic OFDM bit loading algorithm considers the relationship between the received SNR and the bit error probability of gray-coded, rectangular M-QAM modulation through the use of the EVM of the training transmission. An estimate of the EVM for the k^{th} subcarrier is provided in Equation (14), using similar notation as in Equation (3) above.

EVMₖ= \overline{|\hat{x}ₖ−xₖ|²} (14)

Upon inverting the mean EVM, the Post Processing SNR (PPSNR) for each individual subcarrier can be estimated. Therefore, equations for PPSNR as a function of a given probability of error and even M-QAM modulation orders were formulated to generate an offline look-up table containing the linearly-scaled PPSNR values required to achieve BERs in the range of 10⁻⁴ to 10⁻⁶ for each modulation rate.

Modulation order decisions are then performed by the algorithm by comparing an estimate of the subcarrier-based PPSNR values to those in the look-up table such that the most optimal distribution of bits among the subcarriers is allocated. Lastly, if the SNR for the kth subcarrier is less than that required for QPSK, BPSK is selected as the default modulation order.

Also, in this embodiment, to ensure that the subcarriers remain energy tight, power scaling of the individual subcarriers is performed. Therefore, two variations of ABL have been developed for use in the joint algorithm. The power-scaled rate adaptive (PSRA) variation is similar to those “energy-tight” algorithms developed by Campello, et al. (1998), where the non-power-scaled rate adaptive (NPSRA) algorithm does not scale power. It is noted that the NPSRA algorithm is suboptimal because it does not make efficient use of subcarrier symbol energy. Rather, the NPSRA variation assumes average unit power across all subcarriers.

### Joint ABL/PAPR Algorithm

PAPR reduction and ABL complement one another. By reducing the PAPR, more efficient use of the power amplifiers is possible, resulting in the ability to transmit higher data rates for the same BER constraint. To combine both techniques into a unified algorithm, minor modifications must be made in regards to the number of symbol rotations in the SS-CSRI algorithm (i.e., the number of blocks, M, selected to divide the N length of OFDM sequence) due to the fact that, through ABL, some carriers may be allocated more or less data to transmit than others. Specifically, M is determined by the number of modulation orders selected by the ABL algorithm to transmit the OFDM sequence. For example, if the ABL algorithm determines that the optimal bit distribution utilizes a combination of binary phase-shift keying (BPSK), quadrature phase-shift keying (QPSK), and 16-QAM, the number of divisions, M, is 3. Dividing the OFDM sequence into the same number of blocks as modulation orders ensures that only data symbols of the same modulation order may be rotated and inverted. Additionally, another modification was made such that the maximum number of permutation performed, Nₚ, is fixed. Thus, the number of blocks for the SS-CSRI algorithm is determined by the total number of modulation orders in the system such that only data symbols with the same modulation order may be rotated and inverted. Due to this, the maximum number of permutations possible for each “block” of modulation orders is limited by the number of subcarriers capable of transmitting that rate.

Assuming a range of M modulation orders and Nₚ permutations to be performed, the algorithm will first find the maximum permutations possible, Kₘₐₓ, for the modulation order allocated to the smallest number of subcarriers. The algorithm then finds the Kₘₐₓ for the modulation order with the next smallest number of allocated subcarriers. This process continues for M−1 modulation orders. The final modulation order will then consist of

$${N}_{p} - {\sum }_{i}^{M - 1} {K}_{ma {x}_{i}}$$

permutations.

The steps of the ABL/PAPR algorithm are outlined below in a small example assuming Nₚ=90 and three modulation orders, BPSK, QPSK, and 16-QAM. If it is assumed that the number of subcarriers allocated to each modulation rate is 41, 4, and 3, respectively (See Sosa, “A Joint Bitloading and Symbol Rotation Algorithm for Multi Carrier Systems,” Master's thesis, Drexel University, 2011), then:

1) Find Kₘₐₓ for 16-QAM. With 3 subcarriers, a total of 3!=6 permutations are possible.

2) Find Kₘₐₓ for 4-QAM. With 4 subcarriers, a total of 4!=24 permutations are possible.

3) The remaining 90−6−24=60 permutations are performed on the subcarriers carrying BPSK modulated data.

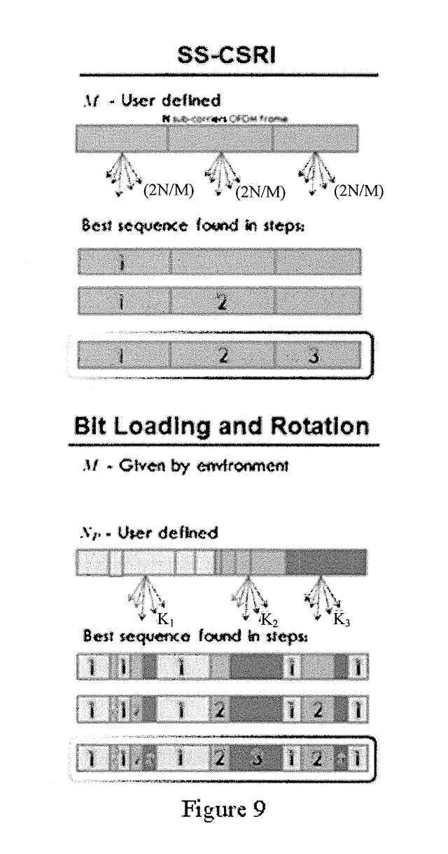

A comparison of the modified joint algorithm and the original SS-CSRI algorithm is provided in FIG. 9. In this implementation with fixed permutation, Nₚ, the amount of control overhead necessary is

$$M {log}_{2} ( \frac{{N}_{p}}{M} ) bits ,$$

rather than the M log₂ (2N/M) bits required in the original SS-SCRI implementation.

### Results

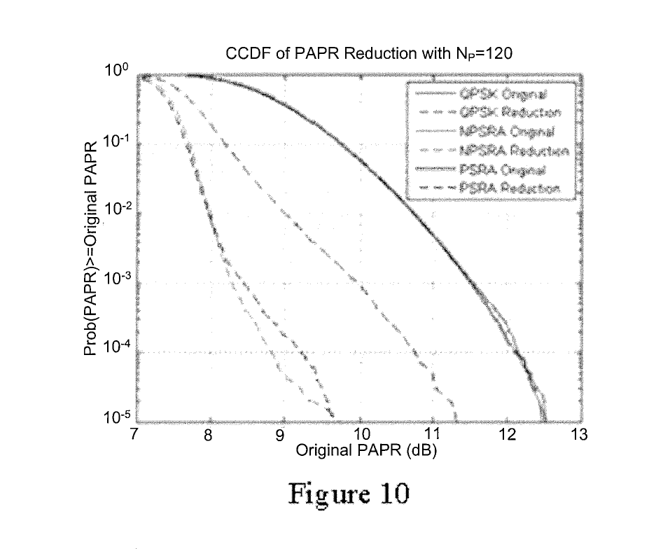

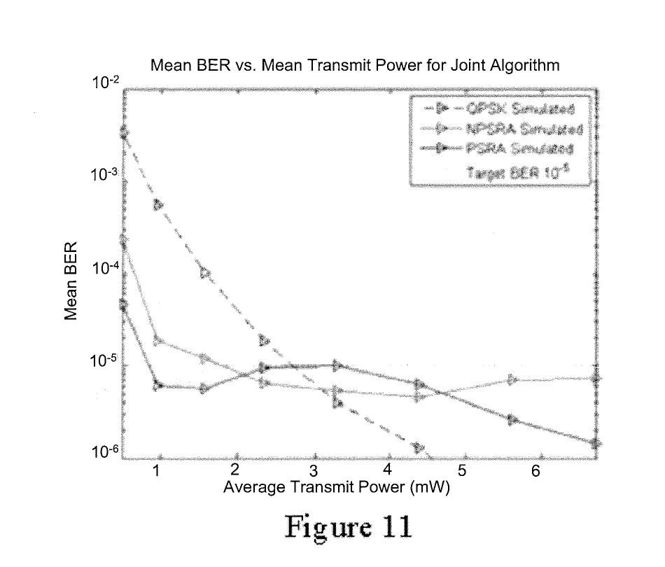

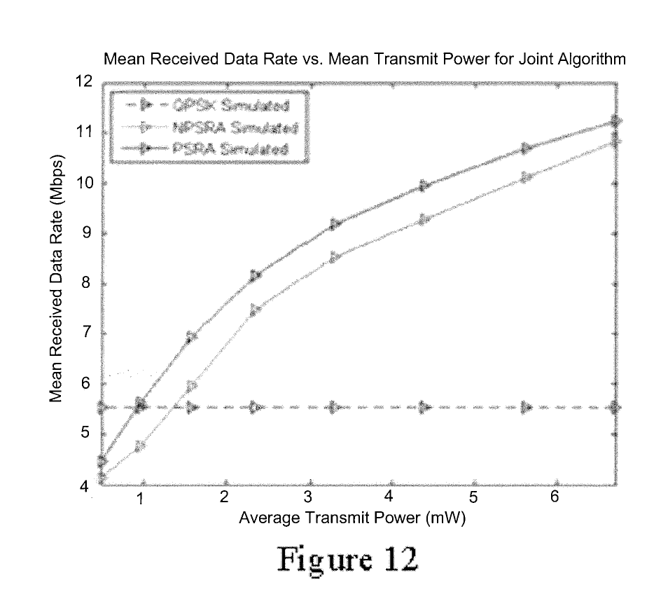

A simulation was performed to compare fixed-rate QPSK modulation and the joint PAPR-reduction and ABL algorithm using both non-power-scaled rate adaptive (NPSRA) and power-scaled rate adaptive (PSRA) bit loading. First, three fixed-rate QPSK packets were transmitted consecutively to acquire an estimate of the EVM for each individual subcarrier. Immediately following these packets, the NPSRA joint algorithm calculated the suboptimal bit distribution according to the mean subcarrier-based EVM and itself transmitted three packets. The PSRA algorithm performs these same tasks. For each physical layer, a total of 20,520 packets composed of 10 OFDM data symbols were transmitted during measurements. The complementary cumulative distribution function (CCDF) of the PAPR for Nₚ=120 permutations was collected (FIG. 10) in addition to the mean BER (FIG. 11) and mean transmitted data rates (FIG. 12)—all under a target BER constraint of 10⁻⁵.

FIG. 10 illustrates simulated PAPR results using a joint adaptive bit loading and PAPR reduction algorithm in accordance with the second embodiment of the invention, where the three physical layers are implemented on top of the symbol rotation framework and compared for fixed rate Quadrature Phase Shift Keying (QPSK), Non-Power Scaled Rate Adaptive (NPSRA) bit-loading, and Power-Scaled Rate Adaptive (PSRA) bit-loading. The solid lines indicate the original PAPR for the QPSK, NPSRA, and PSRA data symbols prior to applying the symbol rotation algorithm, while the dotted lines represent the PAPR after employing symbol rotation for each physical layer.

The reduction in PAPR in FIG. 10 is shown through a CCDF plot. As noted by all three solid lines, the PAPR of the original symbols prior to implementing the modified SS-CSRI algorithm are the same for fixed-rate QPSK and both forms of the joint adaptive algorithm. Upon performing symbol rotation and inversion on fixed-rate QPSK packets, the PAPR is slightly reduced by a maximum of roughly 1 dB, as noted by the QPSK reduction line in FIG. 10. Notably, the joint adaptive algorithm experiences a larger PAPR reduction—roughly three times that for fixed-rate modulation. Interestingly, the NPSRA version of the algorithm achieves the greatest PAPR reduction of roughly 2.9 dB, which is slightly larger than that achieved by the PSRA version. Thus, the PAPR is reduced by at least 2 dB when symbol rotation and bit loading are used together.

FIG. 11 illustrates the ability of the techniques of the invention to adhere to a target bit error rate (BER) over a large range of transmit powers, which is particularly useful for communication applications that require high levels of reliability during transmission. In FIG. 11, the straight dotted line indicates the desired 10⁻⁵ BER target and the bit-loaded physical layers NPSRA and PSRA are capable of remaining below the BER threshold despite increases in the data rate at higher transmitted powers (see FIG. 12). Upon viewing the measured results in FIG. 11, the joint PAPR-reduced rate adaptive algorithm successfully adheres to the target BER even at low transmit powers near 0.5-1.35 mW, unlike fixed-rate QPSK modulation. In fact, QPSK does not achieve the desired average BER until roughly 2.75 mW of transmit power. The increased error rate for fixed-rate QPSK modulation is due to the significant ISI in the ultrasonic channel caused by frequency selectivity.

As previously mentioned, the use of non-adaptive OFDM M-QAM modulation in the ultrasonic channel has been shown to increase data rates above the maximum 5 Mbps achievable using narrowband techniques. However, use of the joint adaptive physical layer further increases the average transmitted data rate to roughly 11 Mbps at average transmit powers near 7 mW, as shown in FIG. 12. With respect to narrowband techniques, this is a significant throughput improvement of approximately 220%.

FIG. 12 illustrates that the ABL/PAPR algorithm of the invention significantly increases the data rate in comparison to fixed-rate modulation schemes, such as QPSK, while adhering to a desired reliability (BER) constraint. As shown in FIG. 12, the fixed-rate transmission can only achieve a maximum of roughly 5 Mbps, where the NPSRA and PSRA bit-loaded physical layers reach data rates of roughly 11 Mbps. From FIG. 12, it is also clear that the joint adaptive algorithm achieves larger average transmitted data rates in comparison to fixed M-QAM modulation. The ability of the adaptive algorithm to significantly improve throughput is explained primarily by the fact that bit-loading exploits higher-quality subcarriers while transmitting fewer bits on weaker subcarriers. The use of hybrid modulations allows the ABL/PAPR algorithm to maintain a desired level of reliability while maximizing throughput. It is further noted that if a higher fixed-rate scheme were chosen to increase the data rate that the desired reliability would be compromised. Thus, the results show the ABL/PAPR algorithm's ability to simultaneously reduce PAPR, adhere to BER constraints, and to increase throughput rates.

Although implementing non-adaptive OFDM M-QAM modulation in the ultrasonic channel alone can increase data rates above the maximum 5 Mbps achievable using narrowband techniques (See Primerano, Kam, and Dandekar, “High Bit Rate Ultrasonic Communication Through Metal Channels,” Information Sciences and Systems, 2009), the use of the joint adaptive physical layer further increases the average transmitted data rate to roughly 11 Mbps at the average transmit powers near 7 mW. With respect to narrowband techniques, this is a significant improvement of approximately 220%. Further, the capability of simultaneously reducing the PAPR and adhering to desired quality of service criteria are added benefits of the ABL/PAPR algorithm.

As those skilled in the art will appreciate from the above description, current narrowband communication techniques are highly limited in the ultrasonic channel due to the acoustic echoing within the metal bulkhead. OFDM greatly improves reliable data throughput in non-penetrating through-metal communication links by approximately 40% in comparison to currently implemented narrowband modulation techniques. Subcarrier-based rate adaptive algorithms further improve throughput by enhancing spectral efficiency. At average PPSNR values of roughly 20 dB, the OFDM-based rate adaptive physical layer of the invention increases average transmitted data rates by approximately 200% while still complying with a strict desired BER. To address the potential ill effects of PAPR and make more efficient use of the power amplifiers in the system, the invention modifies and implements a symbol rotation and inversion-based PAPR reduction algorithm in the adaptive OFDM framework. This joint adaptive physical layer is capable of increasing data rates by roughly 220% in comparison to conventional narrowband techniques at average transmit powers of roughly 7 mW while constrained to a desired BER. Thus, the supplementary modulation techniques of the invention, when applied in the ultrasonic communication link, offer throughput on the order of 11 Mbp and reliability capable of supporting higher-rate network applications below decks on navy ships while avoiding network bottlenecks and maintaining full network connectivity throughout the vessel.

Insubstantial changes from the claimed subject matter as viewed by a person with ordinary skill in the art, now known or later devised, are expressly contemplated as being equivalently within the scope of the claims. For example, the different transducer mounting options and hardware may be used to couple energy through a metal bulkhead using the techniques of the invention. Transducers that do not require physical mating to the bulkhead are desirable due to the reduced mounting complexity and continual system maintenance. Also, additional communication techniques such as more sophisticated data interleaving and channel coding may also be used to further increase reliability in the channel. Therefore, obvious substitutions now or later known to one with ordinary skill in the art are defined to be within the scope of the defined elements.

1. A method of communicating data through metal, comprising the steps of:
modulating data bits onto subcarriers using rate adaptive orthogonal frequency division multiplexing modulation whereby transmission parameters for the modulated data are adapted based on feedback of channel state information of sub-channels of said subcarriers for improving spectral efficiency and reliability of said sub-channels during transmission through the metal;
acoustically transmitting the modulated data bits as OFDM symbols on said sub-carriers through the metal;
receiving the OFDM symbols that have been transmitted through the metal in said sub-channels; and
equalizing the received OFDM symbols using the channel state information applied to each subcarrier.

2. The method of claim 1, wherein said modulating comprises applying an adaptive bit loading algorithm to said data bits so as to maximize a number of bits per OFDM symbol under a fixed energy and bit error rate constraint.

3. The method of claim 1, further comprising, after modulating, reducing peak-to-average power ratio (PAPR) of said subcarriers by rotating and/or inverting symbols to find sequences with reduced PAPR after said rotating and/or inverting.

4. The method of claim 3, further comprising storing information needed to achieve the minimum PAPR at each frame sub-block in a memory and sending said information to a receiver for use in recovering the data bits modulated in said modulating step prior to demodulation at the receiver.

5. The method of claim 1, wherein said modulating comprises quadrature amplitude modulating 512 orthogonal subcarriers spaced at approximately 10 kHz intervals with said data bits.

6. The method of claim 1, wherein said equalizing comprises estimating the complex channel gain independently on each subcarrier from training symbols as:
$${\hat{h}}_{k} = \frac{{y}_{k}}{{x}_{k}} = {h}_{{Tr}_{k}} + \frac{{n}_{{Tr}_{k}}}{\sqrt{{e}_{k}} {x}_{{Tr}_{k }}}$$
where eₖ is the power associated with the k^{th} subcarrier, h_{Trk} is the training channel, x_{Trk} is the k^{th} known training symbol, and n_{Trk} is the k^{th} subcarrier additive white Gaussian noise factor of the k^{th} subcarrier.

7. A system for communicating data through metal, comprising:
first and second acoustic transducers on opposing sides of said metal;
a data modulator that modulates data bits onto subcarriers using rate adaptive orthogonal frequency division multiplexing modulation whereby transmission parameters for the modulated data are adapted based on feedback of channel state information of sub-channels of said subcarriers for improving spectral efficiency and reliability of said sub-channels during transmission through the metal, said data modulator applying said modulated data bits to said first acoustic transceiver for transmission of said data through said metal on said sub-carriers and for receipt of OFDM symbols by said second acoustic transducer that have been transmitted through said metal in said sub-channels;
a signal processor that equalizes the received OFDM symbols using the channel state information applied to each subcarrier; and
a demodulator that demodulates the data bits from the received sub-carriers.

8. The system of claim 7, wherein said data modulator applies an adaptive bit loading algorithm to said data bits so as to maximize a number of bits per OFDM symbol under a fixed energy and bit error rate constraint.

9. The system of claim 7, further comprising a data processing block including a peak-to-average power ratio (PAPR) reducing algorithm that reduces the PAPR of said subcarriers by rotating and/or inverting symbols to find sequences with reduced PAPR after said rotating and/or inverting.

10. The system of claim 9, further comprising a memory that stores information needed to achieve the minimum PAPR at each frame sub-block whereby said information is used prior to demodulation by said demodulator to recover the data bits modulated by said data modulator.

11. The system of claim 7, wherein said data modulator quadrature amplitude modulates 512 orthogonal subcarriers spaced at approximately 10 kHz intervals with said data bits.

12. The system of claim 7, wherein said signal processor estimates the complex channel gain independently on each subcarrier from training symbols as:
$${\hat{h}}_{k} = \frac{{y}_{k}}{{x}_{k }} = {h}_{{Tr}_{k}} + \frac{{n}_{{Tr}_{k}}}{\sqrt{{e}_{k}} {x}_{{Tr}_{k}}}$$
where eₖ is the power associated with the k^{th} subcarrier, h_{Trk} is the training channel, x_{Trk} is the k^{th} known training symbol, and n_{Trk} is the k^{th} subcarrier additive white Gaussian noise factor of the k^{th} subcarrier.
